(19) United States
(12) Patent Application Publication
(10) Pub. No.: US 2025/0389995 A1
(43) Pub. Date: Dec. 25, 2025

(54) DISPLAY DEVICE

(71) Applicant: Sharp Display Technology Corporation, Kameyama City (JP)

(72) Inventor: Takaaki HARADA, Kameyama City (JP)

(21) Appl. No.: 19/230,484

(22) Filed: Jun. 6, 2025

(30) Foreign Application Priority Data
Jun. 19, 2024 (JP) 2024-099133

(51) Int. Cl. G02F 1/1368; G02F 1/1362

(52) U.S. Cl. CPC G02F 1/1368; G02F 1/136222

(57) ABSTRACT

A display device comprises a stack of a color filter (CF) substrate and a thin film transistor (TFT) substrate having a TFT, wherein the TFT substrate has a first side, the CF substrate has a second side overlapping the first side partly, the CF substrate overlaps the TFT substrate at both ends of the second side and has a notch between both ends of the second side, and a flexible printed circuit (FPC) configured to control the TFT is mounted on a region of the TFT substrate corresponding to the notch.

### CROSS-REFERENCE TO RELATED APPLICATION

The present application claims priority from Japanese Application JP2024-099133, the content of which is hereby incorporated by reference into this application.

### BACKGROUND OF THE DISCLOSURE

### Field of the Disclosure

The present disclosure relates to a display device.

### Description of the Related Art

Japanese Unexamined Patent Application Publication No. 2001-209054 discloses a liquid crystal display device including the following: a liquid crystal display element having a liquid crystal held between a pair of substrates, and a semiconductor integrated circuit device provided on a surface adjacent to the liquid crystal on the periphery of one of the pair of substrates; a frame covering the liquid crystal display element; and a spacer provided between the frame and the surface adjacent to the liquid crystal on the periphery of the substrate. The spacer has a protrusion and recess on one side adjacent to the liquid crystal display element, and is structured such that the semiconductor integrated circuit device is fitted in the recess, and that the protrusion is provided with an adhesive on a surface facing a surface of the substrate adjacent to the liquid crystal. This structure can prevent the substrates of the liquid crystal display element from cracking during the assembly of the device. This can improve product quality.

Unfortunately, the display device in Japanese Unexamined Patent Application Publication No. 2001-209054 cannot sufficiently reduce the possibility of such substrate cracking.

### SUMMARY OF THE DISCLOSURE

An object of one aspect of the present disclosure is to achieve a display device with reduced possibility of breakage of its TFT substrate.

To solve the above problem, a display device according to one aspect of the present disclosure includes a stack of a color filter (CF) substrate and a thin film transistor (TFT) substrate having a TFT. The TFT substrate has a first side. The CF substrate has a second side overlapping the first side partly. The CF substrate overlaps the first side at both ends of the second side and has a notch between both ends of the second side. A flexible printed circuit (FPC) configured to control the TFT is mounted on a region of the TFT substrate corresponding to the notch.

The aspect of the present disclosure can achieve a display device with reduced possibility of breakage of its TFT substrate.

### BRIEF DESCRIPTION OF THE DRAWINGS

FIG. 1 is a cross-sectional view of the configuration of main components of a display device according to a first embodiment;

FIG. 2 is a perspective view of a CF substrate and a TFT substrate of the display device according to the first embodiment, viewed from the CF substrate;

FIG. 3 is a cross-sectional view of the configuration of main components of a display device according to a second embodiment;

FIG. 4 is a cross-sectional view of the configuration of main components of a display device according to a third embodiment; and

FIG. 5 is a perspective view of a CF substrate and a TFT substrate of the display device according to the third embodiment, viewed from the CF substrate.

### DETAILED DESCRIPTION OF THE DISCLOSURE

### First Embodiment

An embodiment of the present disclosure will be detailed.

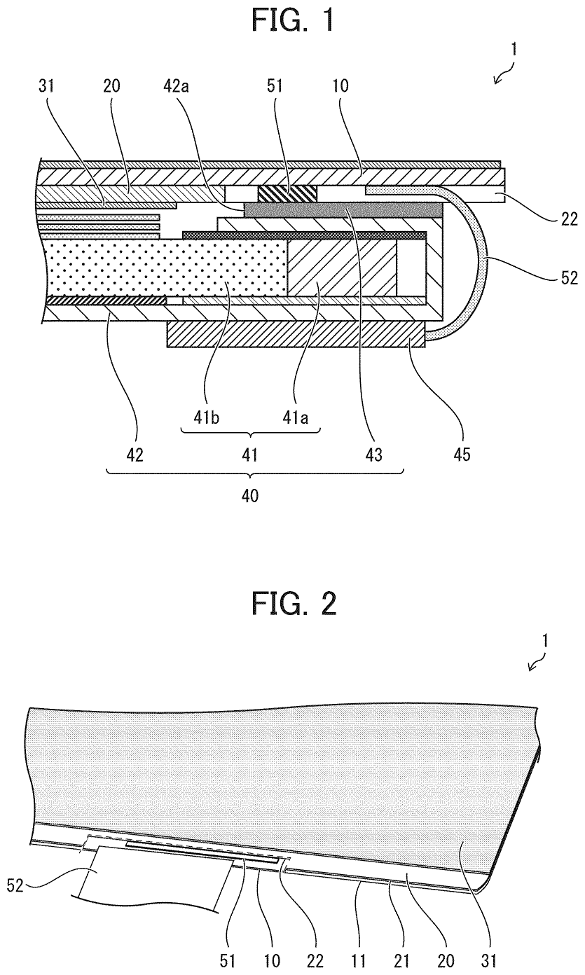

FIG. 1 is a cross-sectional view of the configuration of main components of a display device 1 according to the first embodiment. As illustrated in FIG. 1, the display device 1 includes a color filter (CF) substrate 20 and a thin film transistor (TFT) substrate 10. The CF substrate 20 and the TFT substrate 10 are stacked on each other.

The CF substrate 20 has a plurality of color filters (not shown) that allows only light of specific wavelengths to pass therethrough. The plurality of color filters includes, for example, a red color filter, a green color filter, and a blue color filter.

The TFT substrate 10 has a plurality of TFTs (not shown). The TFT substrate 10 has a structure in which, for instance, the plurality of TFTs is arranged on a glass substrate. The plurality of TFTs is arranged in one-to-one correspondence with the plurality of color filters of the CF substrate 20.

The display device 1 further includes a backlight unit 40. The backlight unit 40 includes a light source 41, a bezel, and fixation tape 43.

The light source 41 causes light to enter the CF substrate 20. The light source 41 includes a light-emitting element 41a that emits light, and a light guide plate 41b that guides the light emitted from the light-emitting element 41a to deflect the light toward the CF substrate 20. The light source 41 thus functions as a planer light source that emits light in a planer manner toward the CF substrate 20. A known light-emitting element can be used as the light-emitting element 41a without any limitations; likewise, a known light guide plate can be used as the light guide plate 41b without any limitations.

The bezel 42 is a case housing the light source 41. The bezel 42 is made of resin for instance. The bezel 42 has an opening 42a for the light from the light source 41 to exit. The CF substrate 20 is stacked on the bezel 42 so as to cover at least a part of the opening 42a. Further, the TFT substrate 10 in the display device 1 is stacked opposite the bezel 42 with respect to the CF substrate 20. Such a scheme of arrangement of the CF substrate 20 and TFT substrate 10 is referred to as a flip panel scheme.

The fixation tape 43 fixes the CF substrate 20 to the bezel 42. Known fixation tape can be used as the fixation tape 43 without any limitations.

The display device 1 further includes a printed wired board (PWB) 45 opposite the TFT substrate 10 and CF substrate 20 with respect to the bezel 42. The PWB 45 is a circuit board that controls the overall operation of the display device 1 in an integrated manner.

The display device 1 further includes a CF polarization plate 31. The CF polarization plate 31 polarizes light incident upon the CF substrate 20 from the backlight unit 40. The CF polarization plate 31 is positioned opposite the TFT substrate 10 with respect to the CF substrate 20.

The display device 1 further includes a chip-on-glass (COG) 51 and a flexible printed circuit (FPC) 52. The COG 51 is a control board that controls the TFTs of the TFT substrate 10. The FPC 52 is a flexible wiring board connecting the PWB 45 and the TFTs on the TFT substrate 10 together.

FIG. 2 is a perspective view of the CF substrate 20 and TFT substrate 10 of the display device 1, viewed from the CF substrate 20. As illustrated in FIG. 2, the TFT substrate 10 has a first side 11. The CF substrate 20 has a second side 21 overlapping the first side 11 partly. The CF substrate 20 has a notch 22 between both ends of the second side 21.

The CF substrate 20 overlaps the TFT substrate 10 in a region including both ends of the second side 21 and excluding the notch 22. On the other hand, the CF substrate 20 does not overlap the TFT substrate 10 in the notch 22.

The FPC 52 is mounted on a region of the TFT substrate 10 corresponding to the notch 22. This can reduce the area of the region in which the TFT substrate 10 does not overlap the CF substrate 20 when compared with, for instance, a configuration in which the entire first side 11 of the TFT substrate 10 does not overlap the CF substrate 20.

The TFT substrate 10 possibly breaks upon impact application. The TFT substrate 10 more highly possibly breaks due to an impact, specifically in the region in which the TFT substrate 10 does not overlap the CF substrate 20 than in the region in which the TFT substrate 10 overlaps the CF substrate 20. In other words, the region of the TFT substrate 10 not overlapping the CF substrate 20 can be regarded as a region in which the TFT substrate 10 is not reinforced by the CF substrate 20.

As earlier described, the display device 1 is structured such that the region in which the TFT substrate 10 does not overlap the CF substrate 20 is smaller than the configuration in which the entire first side 11 of the TFT substrate 10 does not overlap the CF substrate 20. That is, the region in which the TFT substrate 10 is not reinforced by the CF substrate 20 has a small area. This reduces, in the display device 1, the possibility that the TFT substrate 10 breaks due to an impact.

Further, the COG 51 in the display device 1 is mounted on a surface of the TFT substrate 10 corresponding to the notch 22 and facing the bezel 42. In the foregoing flip panel scheme, mounting the COG 51 in this manner enables the display device 1 to have a so-called full-flat structure, in which the CF substrate 20 and the COG 51 do not protrude opposite the bezel 42 with respect to the TFT substrate 10.

In the example illustrated in FIG. 1, the CF substrate 20 does not cover a region of the opening 42a corresponding to the notch 22, but covers the other regions of the same. However, the CF substrate 20 may cover the entire opening 42a.

### Second Embodiment

Another embodiment of the present disclosure will be described. It is noted that for convenience in description, components having the same functions as those of the components described in the foregoing embodiment will be denoted by the same signs, and that their descriptions will not be repeated.

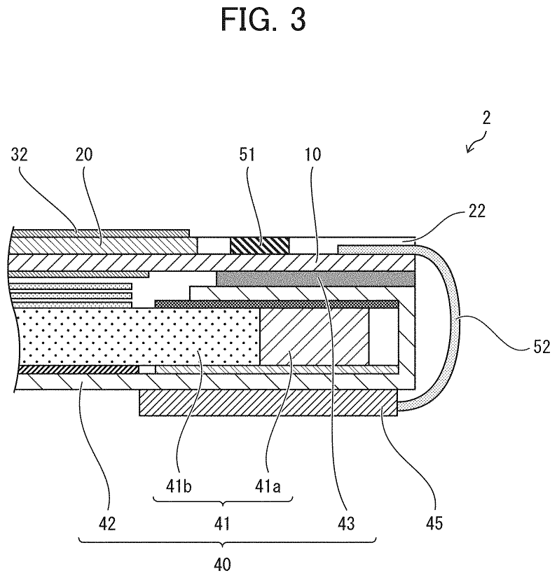

FIG. 3 is a cross-sectional view of the configuration of main components of a display device 2 according to the second embodiment. As illustrated in FIG. 3, the display device 2 is different from the display device 1 in the positional relationship between the TFT substrate 10 and CF substrate 20. As earlier described, the display device 1 is structured such that the TFT substrate 10 is stacked opposite the bezel 42 with respect to the CF substrate 20. In contrast to this, the display device 2 is structured such that the CF substrate 20 is stacked opposite the bezel 42 with respect to the TFT substrate 10.

The display device 2 further includes a CF polarization plate 32. The CF polarization plate 32 polarizes light emitted from the CF substrate 20. The CF polarization plate 32 is positioned opposite the TFT substrate 10 with respect to the CF substrate 20.

Further, the COG 51 in the display device 2 is mounted on a region of the TFT substrate 10 corresponding to the notch 22 and being opposite the bezel 42 with respect to the TFT substrate 10. The display device 2 is thus structured, unlike the display device 1, such that the CF substrate 20 and the COG 51 protrude from the surface of the TFT substrate 10 opposite the bezel 42. That is, the structure of the display device 2 is not a so-called full-flat structure.

In the display device 2, the TFT substrate 10 has an end supported by the bezel 42. However, the COG 51 possibly breaks upon local impact application to the COG 51 protruding from the TFT substrate 10. In addition, the impact at this time propagates to the TFT substrate 10 as well, via the COG 51, so that the TFT substrate 10 also possibly breaks. The possibility that the COG 51 and the TFT substrate 10 break due to an impact upon the COG 51 increases along with increase in the area of a region around the COG 51 in which the CF substrate 20 does not overlap the TFT substrate 10.

The COG 51 in the display device 2 is mounted on the region of the TFT substrate 10 corresponding to the notch 22. That is, the CF substrate 20 overlaps the TFT substrate 10 in a region except the notch 22. Thus, the region in which the CF substrate 20 does not overlap the TFT substrate 10 is small in area around the COG 51, when compared with the configuration in which the entire first side 11 of the TFT substrate 10 does not overlap the CF substrate 20. This reduces the possibility that the COG 51 and the TFT substrate 10 break due to an impact upon the COG 51.

The TFT substrate 10 covers the entire opening 42a in the example illustrated in FIG. 3. However, the TFT substrate 10 only needs to cover at least a part of the opening 42a, and it does not necessarily need to cover the entire opening 42a.

### Third Embodiment

Further another embodiment of the present disclosure will be described.

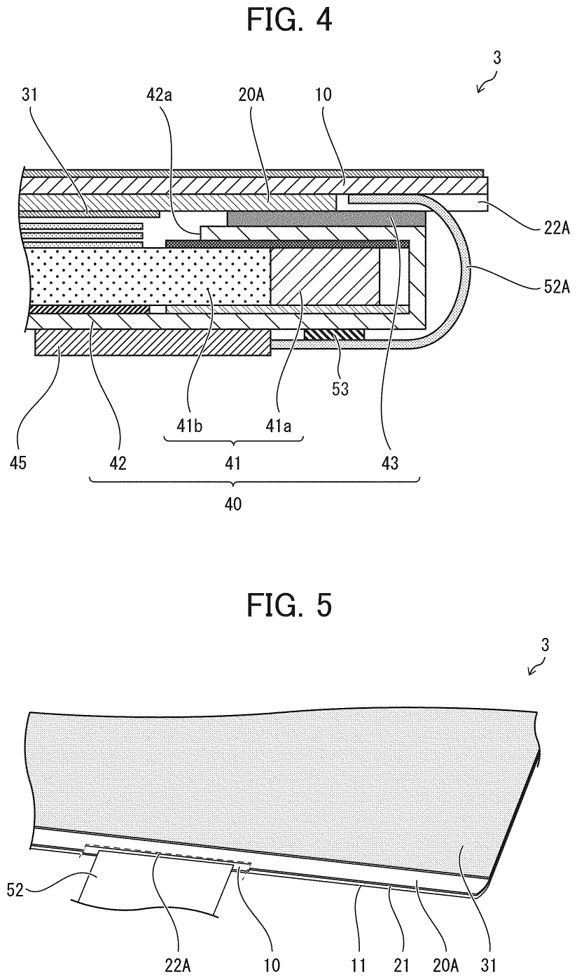

FIG. 4 is a cross-sectional view of the configuration of main components of a display device 3 according to the third embodiment. As illustrated in FIG. 4, the display device 3 is different from the display device 1 in that the display device 3 includes a chip-on-film (COF) 53 instead of the COG 51, and includes an FPC 52A instead of the FPC 52.

The COF 53 is a control board that controls the TFTs of the TFT substrate 10. That is, the function of the COF 53 is the same as the function of the COG 51. However, the COF 53 is mounted on the FPC 52A, whereas the COG 51 is mounted on the TFT substrate 10. Specifically, the COF 53 may be mounted on the FPC 52A so as to be positioned opposite the TFT substrate 10 with respect to the bezel 42.

The FPC 52A is a flexible wiring board connecting the PWB 45 and the TFTs on the TFT substrate 10 together. Furthermore, as earlier described, the COF 53 in the display device 3 is mounted on the FPC 52A. The FPC 52A thus connects the COF 53 and the TFTs on the TFT substrate 10 together.

The display device 3 is also different from the display device 1 in that the display device 3 includes a CF substrate 20A instead of the CF substrate 20. The CF substrate 20A is different from the CF substrate 20 in that the CF substrate 20A has a notch 22A instead of the notch 22.

FIG. 5 is a perspective view of the CF substrate 20A and TFT substrate 10 of the display device 3, viewed from the CF substrate 20A. As earlier described, the display device 3 does not include the COG 51. That is, the display device 3 does not need a region for mounting the COG 51 on the TFT substrate 10. This enables the notch 22A in the display device 3 to be smaller, as illustrated in FIG. 5, than the notch 22 in the display device 1.

Providing the notch 22A smaller than the notch 22 makes the area of a region in which the TFT substrate 10 does not overlap the CF substrate 20A in the display device 3, smaller than the area of the region in which the TFT substrate 10 does not overlap the CF substrate 20 in the display device 1. Consequently, the display device 3 further reduces the possibility that the TFT substrate 10 breaks due to an impact than the display device 1.

Further, the CF substrate 20A in the display device 3 may overlap the TFT substrate 10 on the entire second side 21. In this case, a panel terminal electrically connected to the TFTs of the TFT substrate 10 may be provided so as to penetrate the CF substrate 20A. Further, in this case, the FPC 52A may be mounted on the CF substrate 20A so as to be connected to the panel terminal. This enables the display device 3 to further reduce the possibility that the TFT substrate 10 breaks due to an impact.

The present disclosure is not limited to the foregoing embodiments. Various modifications can be made within the scope of the claims. An embodiment that is obtained in combination as appropriate with the technical means disclosed in the respective embodiments is also encompassed within the technical scope of the present disclosure. Furthermore, combining the technical means disclosed in the respective embodiments can form a new technical feature.

While there have been described what are at present considered to be certain embodiments of the disclosure, it will be understood that various modifications may be made thereto, and it is intended that the appended claim cover all such modifications as fall within the true spirit and scope of the disclosure.

What is claimed is:

1. A display device comprising a stack of a color filter (CF) substrate and a thin film transistor (TFT) substrate having a TFT,
wherein the TFT substrate has a first side,
the CF substrate has a second side overlapping the first side partly,
the CF substrate overlaps the TFT substrate at both ends of the second side and has a notch between both ends of the second side, and
a flexible printed circuit (FPC) configured to control the TFT is mounted on a region of the TFT substrate corresponding to the notch.

2. The display device according to claim 1, further comprising a backlight unit including a light source configured to cause light to enter the CF substrate, and a bezel housing the light source,
wherein the bezel has an opening for the light to exit,
the CF substrate is stacked on the bezel so as to cover at least a part of the opening,
the TFT substrate is stacked opposite the bezel with respect to the CF substrate, and
a chip-on-glass (COG) configured to control the TFT is further mounted on a region of the TFT substrate corresponding to a region in which the CF substrate is notched, and facing the bezel.

3. The display device according to claim 1, further comprising a backlight unit including a light source configured to cause light to enter the CF substrate, and a bezel housing the light source,
wherein the bezel has an opening for the light to exit,
the TFT substrate is stacked on the bezel so as to cover at least a part of the opening,
the CF substrate is stacked opposite the bezel with respect to the TFT substrate, and
a COG configured to control the TFT of the TFT substrate is further mounted on a region of the TFT substrate corresponding to a region in which the CF substrate is notched, and being opposite the bezel with respect to the TFT substrate.

4. The display device according to claim 1, further comprising a backlight unit including a light source configured to cause light to enter the CF substrate, and a bezel housing the light source,
wherein the bezel has an opening for the light to exit,
the CF substrate is stacked on the bezel so as to cover at least a part of the opening,
the TFT substrate is stacked over the CF substrate, and
a chip-on-film (COF) configured to control the TFT of the TFT substrate is mounted on the FPC.
